(19) United States
(12) Patent Application Publication
(10) Pub. No.: US 2002/0140849 A1
(43) Pub. Date: Oct. 3, 2002

(54) Wearable transmitting/receiving device

(76) Inventors: David Neil Slatter, Bristol (GB); Richard Oliver Kahn, Oakland, CA (US); Andrew Arthur Hunter, Bristol (GB)

Correspondence Address: HEWLETT-PACKARD COMPANY, Intellectual Property Administration, P.O. Box 272400, Fort Collins, CO, 80527-2400, US

(21) Appl. No.: 10/078,742

(22) Filed: Feb. 19, 2002

(30) Foreign Application Priority Data
Mar. 28, 2001 (GB) 01077988.1

(51) Int. Cl. H04N 5/225

(52) U.S. Cl. 348/375; 348/207.99

(57) ABSTRACT

A wearable camera arranged to be worn on a user's clothing comprises a lens section 28 which is disguised in a piece of jewellery 30. The piece of jewellery is connected to a rear electronics portion 26 by means of an electrically conducting pin 29. The rear electronics portion 26 houses control means including a semi-conductor memory 26a, power supply 26b, control circuitry 26c and circuitry 26d for controlling the gain setting of a CMOS sensor 28a in the lens section 28.

This invention relates to a wearable receiving/transmitting device.

Portable cameras have been available for a reasonable length of time. The cameras are intended to be worn on a user's clothing in a covert form.

Disadvantages arise with this type of device because the unit is still too large and too heavy to comfortably sit on a wearer's clothing. They are also obtrusive and unsightly.

Also, there are available cameras and other electronics disguised as a part of eye glasses, but these presently require bulky eye wear, which many users are unwilling to wear, especially users who do not ordinarily wear glasses.

It is an object of the present invention to address the above mentioned disadvantages.

According to a first aspect of the present invention a wearable transmitter/receiver comprises a front portion and a rear portion, wherein the front portion includes a transmission/reception section and is adapted to be worn outside a wearer's clothing, and wherein the rear portion includes a control section and is adapted to be worn inside at least part of the wearer's clothing, in which the front and rear portions are operable to communicate electrically with one another.

The transmitter/receiver may be either a transmitter or a receiver, or may be both a transmitter and a receiver.

The transmitter/receiver may be a wearable electromagnetic (EM) radiation transmitter/receiver.

The front portion may include an infra red (IR) transmitter. The front portion may include a radio transmitter or a visible light transmitter or an ultrasound transmitter.

The control section of the rear portion may control the transmission/reception section.

The control section may be programmable.

The front portion may include image capture means, which means are preferably a camera lens and an electronic light sensitive element, such as a charge coupled device (CCD). The image capture means may be operable to capture moving and/or still images.

The control section of the rear portion may include control means for the image capture means, which may include automatic gain adjustment means. Alternatively automatic gain adjustment means may be located in the front portion. The rear portion may also include storage means for storage of captured images, said storage means may be a memory section.

The front and rear portions may be electrically connected by means of an electronically conducting connection pin, which is preferably arranged to extend through a wearer's clothing between the front and rear portions. The pin preferably projects from the rear portion to be received in a corresponding opening in the front portion.

The electrically conducting connection pin may have multiple conduction paths, to pass power and data between the front and rear portions for example.

The front and rear portions may alternatively be inductively coupled. In which case the front and rear portions may be held in proximity to one another magnetically.

The front portion may be disguised, preferably as a piece of jewellery, such as a brooch or badge. When so disguised the jewellery may be configured as an antenna.

The transmitter/receiver may have a plurality of different front portions all being differently shaped, preferably to blend with, or be suitable with, a wearer's clothing and all being operable to be used with the same rear portion.

According to a second aspect of the present invention a wearable transmitter/receiver comprises a front portion and a rear portion, wherein the rear portion is a control section and the front portion is one of a plurality of interchangeable transmission/reception sections adapted to be secured to the rear portion and to communicate electrically therewith, wherein the front portion is disguised to suit a wearer's clothing.

The front portion may be disguised to be less visible against clothing, or may be disguised as a decorative feature.

All of the features disclosed herein may be combined with any of the above aspects in any combination.

Specific embodiments of the present invention will now be described, by way of example, and with reference to the accompanying drawings, in which:

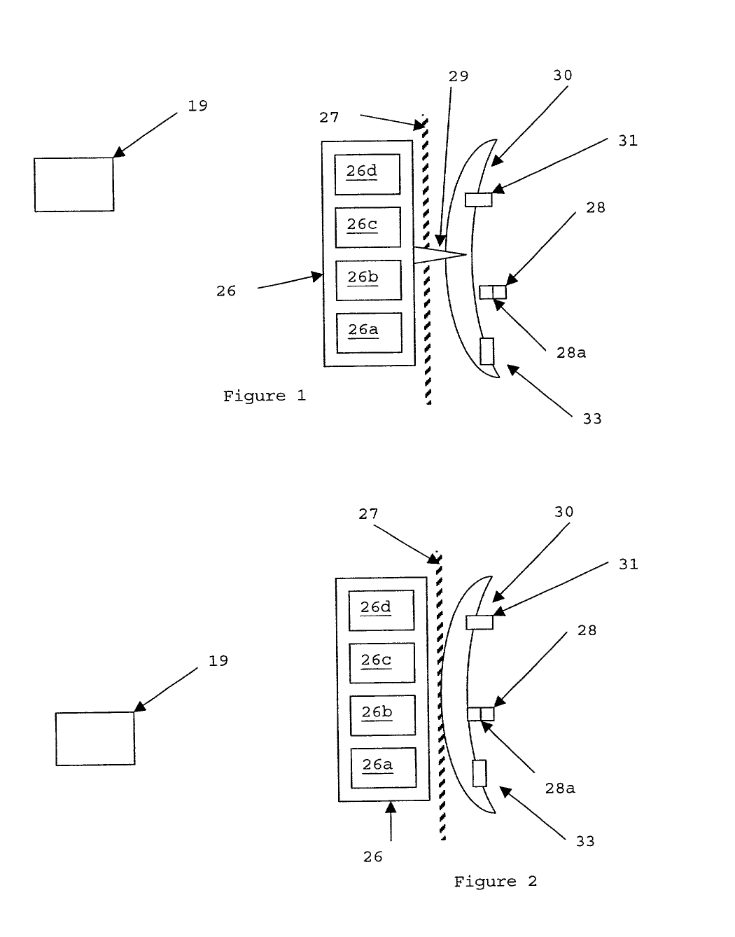

FIG. 1 is a schematic cross sectional side view of a miniature camera disguised in a piece of jewellery having an electronic portion of the camera secured behind a wearer's clothing; and

FIG. 2 is a schematic cross-sectional side view of a camera disguised in jewellery inductively coupled to a rear control portion.

A camera 10 is disguised to resemble a piece of jewellery 30 or integrated with common fashion accessories such as a tie clip. The jewellery includes a lens section 28 and antenna 31. An electronic portion of the camera 10 is positioned in an electronics module 26 behind the user's clothing 27, while the jewellery 30 clips to the front of the user's clothing 27. A pin 29 penetrates the user's clothing 27, fixes the jewellery 30 in place, and electrically mates the two parts together. This construction works particularly well because for most efficient operation the lens section 28 needs to be located on the outside of a user's clothing 27.

The electronics module 26 may contain a “Blue tooth” (a high frequency broadcast standard) transmission module, with the jewellery 30 including the antenna 31 operable to transmit signals to a Blue tooth standard which can transmit signals over a short distance, e.g. from the camera 10 to a receiver module 19 elsewhere on a user's body or in a bag carried by the user. The signals received by the receiver module 19 could then be stored or transmitted further to a network remote from the user. In this way a bulkier storage device could be located in the receiver module 19 where it is more easily carried. Also a bulkier transmitter for transmission to a remote receiver could also more easily be stored in the receiver module 19.

Many different types and shapes, sizes and colours of jewellery 30 can be envisaged in order to best achieve an unobtrusive camera 10 which can be worn by a user with a variety of clothing. The jewellery 30 may be similar to a badge, and/or may be of type more suitable or more likely to be worn by man.

The jewellery 30 may carry a photovoltaic cell 33 to provide power for the camera 10, which power may be stored in a power supply 26b in the electronics module 26.

The electronics module 26 also includes a semiconductor memory 26a for electronic storage of images captured by the camera lens section 28, as well the power supply 26b for the camera and control circuitry 26c for the camera.

The pin 29 forms an electrical connection to allow receipt of the electrical signals corresponding to a picture from the camera lens section 28 and also to send power from the electronics module 26 to the camera lens section 28.

The pin 29 may have multiple conduction paths, such as a path for power and a path for data. There may be multiple paths for different types of data and a further path for power.

The multiple paths may be provided by a plurality of separate pins, or by concentric ring-shaped connections, as used in an audio socket for example.

Image capture is achieved in this example by a CMOS sensor 28a which is part of the lens section 28 on the outside of the user's clothing 27. Electrical signals corresponding to the captured picture generated by the CMOS 28a sensor are then transmitted through the pin 29 to the storage section 26a in the electronics module 26.

The lens section 28 is designed with a wide angle lens and a high resolution CMOS sensor 28a. The resolution is sufficient such that the image quality is not significantly impaired when the final image consists of an area cropped from the full wide angle image.

The electronics module 26 also includes circuitry 26d for controlling the gain setting of the CMOS sensor 28a to achieve a desired picture quality. The circuitry for controlling the gain settings may alternatively be located in the camera lens section 28.

The camera lens section 28 and associated electronics may also be used to capture moving images, as well as still images, which can also be stored in the electronics module 26.

Image capture may be triggered at set intervals of time or by dynamic events, such as laughter or gestures detected by the lens section 28.

When used for moving images the motion of a user wearing the jewellery based camera on their clothing may cause problems for stabilisation of the image captured. A wide variety of image stabilization programs are known and are used in relation to handheld video cameras. It is believed that suitable amendment of this type of image stabilising software will achieve a stabilised image for use with the camera described above.

The electronics module 26 could be relatively thin and wide to spread the weight over a larger area, thereby reducing the depth and so the risk of injury caused by the internal part being forced against the body.

The antenna 31 or another transmitter type could be configured to send information to or from a personal digital assistant (PDA) and onto or from another device, such as a printer for printing or PC for transferring other data. This would ensure that the PDA need not be pointed so accurately at the device, because the transmission from the antenna 31 would be broader than the directional IR beam of a PDA. The PDA may also be stored in a user's pocket or bag and have a wire or radio link to the camera 10 and its antenna 31 to allow reception by the antenna 31, with data etc being passed to the PDA.

If transmitting radio frequencies, the antenna could be internal, e.g. in the electronics module 26.

The reason for having the possibility of replaceable heads for jewellery is to allow for concealment of the camera lens section 28 or transmitter. Also heads could be replaced to change functions, i.e. to change from a stills camera to a video camera or the like.

Another possibility for connecting the jewellery or front piece to the rear electronics module 26 would be to have inductive coupling between the front and rear portions, see FIG. 2. With this method existing methods of transmitting power and data between the front and rear portions could be used. Electrical signals could be passed through the garment from the front portion to the electronics module 26. The benefit of such an arrangement would be that no piercing of the clothing 27 is required.

Although a camera 10 is shown in the FIG. 1 arrangement, other embodiments can relate to other wearable transmitters or receivers. One possibility is an infrared emitting tag or badge, used for example to identify the wearer. Such an IR transmitter, emitting (for example) a coded IR signal, can be used to identify a subject appearing in photographs—this arrangement is described in the applicant's copending British patent application of even date entitled “Automatic Image Capture”.

The invention described herein in the different embodiments shown advantageously solves the problem of having a discrete wearable (EM) transmitter/receiver which can be unobtrusively worn on a wearer's clothing. By providing separation between the parts which must be on the exterior of a wearer's clothing (such as a camera head) and the electronics which can be behind a user's clothing, the device as described can be worn discretely and carried much more comfortably.

The invention is not restricted to the embodiments described above.

1. A wearable electromagnetic (EM) radiation transmitter/receiver comprises a front portion and a rear portion, wherein the front portion includes a transmission/reception section and is adapted to be worn outside a wearer's clothing, and wherein the rear portion includes a control section and is adapted to be worn inside at least part of the wearer's clothing, in which the front and rear portions are operable to communicate electrically with one another, and are physically connected to one another.

2. A wearable transmitter/receiver as claimed in claim 1, in which the front portion is secured to the rear portion.

3. A wearable transmitter/receiver as claimed in claim 1, in which the front portion includes a radio transmitter.

4. A wearable transmitter/receiver as claimed in claim 1, in which the control section of the rear portion controls the transmission/reception section.

5. A wearable transmitter/receiver as claimed in claim 1, in which the front portion includes image capture means.

6. A wearable transmitter/receiver as claimed in claim 5, in which the rear portion includes control means for the image capture means.

7. A wearable transmitter/receiver as claimed in claim 5, in which the rear portion also includes storage means for storage of captured images.

8. A wearable transmitter/receiver as claimed in claim 1, in which the front and rear portions are electrically connected by means of an electrically conducting connection pin.

9. A wearable transmitter/receiver as claimed in claim 8, in which the electrically conducting connection pin is arranged to extend through a wearer's clothing between the front and rear portions.

10. A wearable transmitter/receiver as claimed in claim 8, in which the electrically conducting connection pin projects from the rear portion to be received in a corresponding opening in the front portion.

11. A wearable transmitter/receiver as claimed in claim 8, in which the electrically conducting connection pin has multiple conduction paths.

12. A wearable transmitter/receiver as claimed in claim 8, which includes a plurality of electrically conducting connection pins arranged to connect the front and rear portions.

13. A wearable transmitter/receiver as claimed in claim 1, in which the front portion is disguised as a piece of jewellery, such as a brooch or badge.

14. A wearable transmitter/receiver as claimed in claim 1, in which the transmitter/receiver has a plurality of different front portions all being differently shaped to blend with, or be suitable with, a wearer's clothing and all being operable to be used with the same rear portion.

15. A wearable transmitter/receiver comprises a front portion and a rear portion, wherein the rear portion is a control section and the front portion is one of a plurality of interchangeable transmission/reception sections adapted to be secured to the rear portion and to communicate electrically therewith, wherein the front portion is disguised to suit a wearer's clothing.

16. A wearable transmitter/receiver as claimed in claim 15, in which the front portion is disguised to be less visible against clothing.

17. A wearable transmitter/receiver as claimed in claim 15, in which the front portion is disguised as a decorative feature.

18. A wearable electromagnetic (EM) radiation transmitter/receiver comprises a front portion and a rear portion, wherein the front portion includes a transmission/reception section and is adapted to be worn outside a wearer's clothing, and wherein the rear portion includes a control section and is adapted to be worn inside at least part of the wearer's clothing, in which the front and rear portions are operable to communicate electrically with one another, and are physically connected to one another, in which the front and rear portions are electrically connected by means of an electrically conducting connection pin.

19. A wearable electromagnetic (EM) radiation transmitter/receiver comprises a front portion and a rear portion, wherein the front portion includes a transmission/reception section and is adapted to be worn outside a wearer's clothing, and wherein the rear portion includes a control section and is adapted to be worn inside at least part of the wearer's clothing, in which the front and rear portions are operable to communicate electrically with one another, in which the front portion is secured to the rear portion.
